(19) United States
(12) Patent Application Publication
(10) Pub. No.: US 2018/0292005 A1
(43) Pub. Date: Oct. 11, 2018

(54) REDUNDANT HAZARD MITIGATION METHODS FOR AN ETRS CONTROLS ARCHITECTURE

(71) Applicant: GM GLOBAL TECHNOLOGY OPERATIONS LLC, Detroit, MI (US)

(72) Inventors: Vijay A. Neelakantan, Rochester Hills, MI (US); Suresh Gopalakrishnan, Troy, MI (US); Christopher G. Benson, Rochester Hills, MI (US)

(21) Appl. No.: 15/480,426

(22) Filed: Apr. 6, 2017

(51) Int. Cl. F16H 61/32; G05D 3/00

(52) U.S. Cl. CPC F16H 61/32; F16H 2061/326; G05D 3/00

(57) ABSTRACT

A method for retracting an extended pin of a sliding camshaft actuator wherein the actuator includes a magnetic field generating coil, a magnetic piston in connection with the extended pin operable to be actuated by the magnetic field generating coil, and a pin stop plate. The method comprises creating an air gap between the magnetic piston and the pin stop plate and reversing voltage on the magnetic field generating coil to retract the extended pin.

### FIELD

The present invention generally relates to redundant hazard mitigation methods for an electronic transmission range selection (ETRS) controls architecture.

### BACKGROUND

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

A typical automatic transmission includes a hydraulic control system that is employed to provide cooling and lubrication to components within the transmission and to actuate a plurality of torque transmitting devices. These torque transmitting devices may be, for example, friction clutches and brakes arranged with gear sets or in a torque converter. The conventional hydraulic control system typically includes a main pump that provides a pressurized fluid, such as oil, to a plurality of valves and solenoids within a valve body. The main pump is driven by the engine of the motor vehicle.

The valves and solenoids are operable to direct the pressurized hydraulic fluid through a hydraulic fluid circuit to various subsystems including lubrication subsystems, cooler subsystems, torque converter clutch control subsystems, and shift actuator subsystems that include actuators that engage the torque transmitting devices. The pressurized hydraulic fluid delivered to the shift actuators is used to engage or disengage the torque transmitting devices in order to obtain different gear ratios.

The transmission generally operates in a plurality of modes of operation including out-of-Park driving modes and a Park mode. The out-of-Park driving modes generally include the forward gear or speed ratios (i.e. a Drive mode), at least one reverse gear or speed ratio (i.e. a Reverse mode), and a Neutral mode. Selection of the various driving modes is typically accomplished by engaging a shift lever or other driver interface device that is connected by a shifting cable or other mechanical connection to the transmission.

Alternatively, the selection of a driving mode may be controlled by an ETRS system, also known as a “shift by wire” system. In an ETRS system, selection of the driving modes is accomplished through electronic signals communicated between the driver interface device and the transmission. The ETRS system reduces mechanical components, increases instrument panel space, enhances styling options, and eliminates the possibility of shifting cable misalignment with transmission range selection levers. New propulsion system architectures may no longer rely upon clutches and, thus, may no longer incorporate a hydraulic control system.

These control systems must meet specific safety requirements for new transmission and vehicle designs during particular failure modes of operation. Thus, there a need exists for hazard mitigation strategies that have application to ETRS controls architectures. For example, a single element failure shall not cause the system to go from the commanded Park state to the unintended Out of Park state, which can cause a hazard condition.

### SUMMARY

One or more exemplary embodiments address the above issue by providing redundant hazard mitigation methods for an ETRS controls architecture. More particularly, exemplary embodiments relate to a redundant hazard mitigation method for an ETRS controls architecture that includes. Another aspect of the exemplary embodiment includes sending a shift position command to the ETRS actuator module. And yet another aspect includes disabling the ETRS actuator module after the command to shift position is executed.

Still other aspects wherein enabling also includes sending an enable signal from a master controller to the ETRS actuator module in response to a driver input to shift. And another aspect wherein the ETRS actuator module comprises an actuator controller in communication with an actuator motor.

A further aspect of an exemplary embodiment wherein the actuator controller and the actuator motor are in communication with a power supply relay. And another aspect of the exemplary embodiment wherein enabling further includes controlling the activation of the power supply relay with the master controller to provide electric power to the ETRS actuator module. Yet another aspect of the exemplary embodiment wherein an H-bridge circuit is in communication between the actuator controller and the actuator motor to regulate supply power to the actuator motor. And another aspect wherein an H-bridge circuit is in communication between the master controller and the actuator motor to regulate supply power to the actuator motor. Still another aspect as according to the exemplary embodiment wherein enabling further includes sending an enable signal from the actuator motor controller to the H-bridge in response to a driver command to shift. And still another aspect as according to the exemplary embodiment wherein enabling further includes sending an enable signal from the master controller to the H-bridge in response to a driver command to shift.

### BRIEF DESCRIPTION OF THE DRAWINGS

The present exemplary embodiments will be better understood from the description as set forth hereinafter, with reference to the accompanying drawings, in which:

FIG. 1 is an illustration of a block diagram for a hazard mitigation strategy for an ETRS controls architecture in accordance with aspects of the exemplary embodiment;

FIG. 2 is an illustration of a block diagram for an additional hazard mitigation strategy for an ETRS controls architecture in accordance with aspects of an exemplary embodiment; and

FIG. 3 is an illustration of an algorithm for a redundant hazard mitigation method for an ETRS controls architecture as according to an exemplary embodiment.

### DETAILED DESCRIPTION OF THE INVENTION

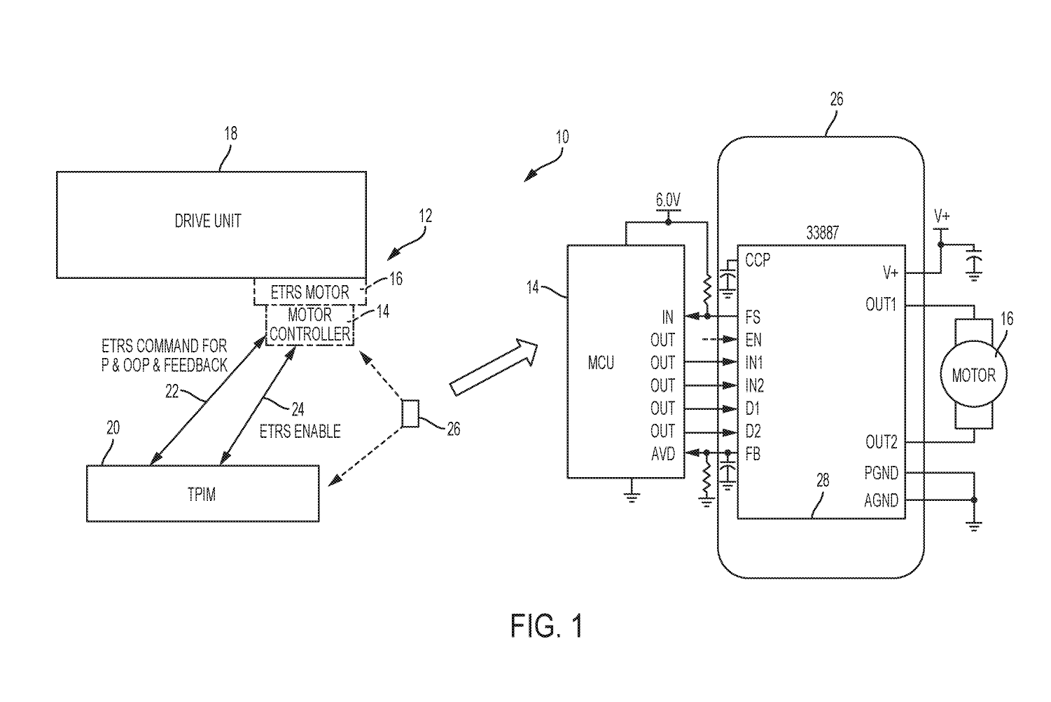

The following description is merely exemplary in nature and is not intended to limit the present disclosure, application, or uses thereof. FIG. 1 provides an illustration of a block diagram 10 for a hazard mitigation strategy for an ETRS controls architecture in accordance with aspects of the exemplary embodiment. The ETRS controls architecture 10 includes an ETRS actuator module 12 primarily consisting of an actuator motor controller 14 and an actuator motor 16. The actuator motor controller 14 governs the performance of the actuator motor 16 such as start/stop, forward/reverse, fast/slow speed and variable torque. It is appreciated that the actuator motor controller 14 may reside in the actuator module 12, be integrated within another module, or be a stand-alone component and still be operable to perform its intended purpose.

The actuator motor 16 is responsible for driving the mechanism to initiate a shift in the shift box (not shown) of the ETRS while a drive unit 18 is responsible for driving the mechanical connections and devices embodied in the transmission (not shown) such that the desired torque, acceleration, and direction is translated to the vehicle wheels.

A master controller 20 is in communication with the ETRS actuator module 12, more particularly the motor actuator controller 14, through bi-directional communication lines (22, 24) which can deliver and receive various signals including, but not limited to, enable/disable, sensor data, instructions, commands, supply power, and diagnostic codes. The master controller 20 may also be integrated with one or more application specific controllers, e.g., the motor actuator controller, which are operable to a control a specific function or multiple functions as according to aspects of the exemplary embodiment.

An H-bridge circuit 26 is disposed between the actuator motor controller 14 and the actuator motor 16 and is operable to deliver a commanded electric current to the actuator motor 16 bi-directionally in response to instructions received from the actuator motor controller 14. The H-bridge circuit 26 can be integrated into the actuator motor controller 14 or the master controller 20. The H-bridge circuit 26 includes an enable line 28 that can be toggled on or off with an appropriate signal received from either the actuator motor controller 14 or the master controller 20 in accordance with exemplary embodiments. In one exemplary embodiment, an H-bridge circuit 26 is in communication between the actuator motor controller 14 and the actuator motor 16 to regulate electric power to the actuator motor 16.

Accordingly, enabling an ETRS position shift further requires sending an enable signal from the actuator motor controller 14 to the H-bridge 26 in response to a driver command to shift. In another embodiment, the H-bridge circuit 26 is in communication between the master controller 20 and the actuator motor 16 to regulate electric power to the actuator motor 16. In this case, enabling an ETRS position shift would require sending an enable signal from the master controller 20 to the H-bridge 26 in response to a driver command to shift.

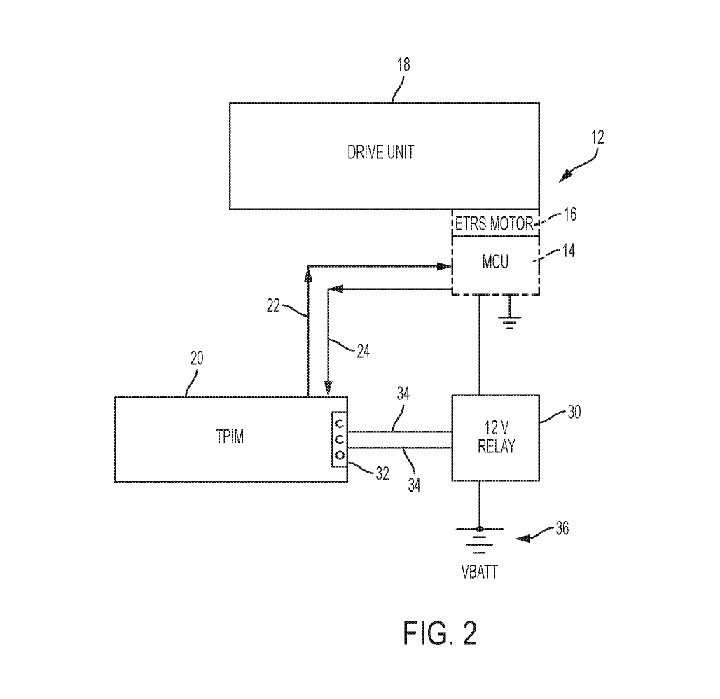

The FIG. 2 is an illustration of a block diagram for an alternative hazard mitigation strategy for an ETRS controls architecture in accordance with aspects of an exemplary embodiment. In this case, the ETRS controls architecture includes a power supply relay 30, e.g., 12 volt relay, in communication with a power source output unit 32 of the master controller 20, e.g., a current controlled output (CCO), through signal lines 34 and is configured to deliver a supply voltage 36 to the actuator motor controller 14 and the actuator motor 16 in response to an enable signal from the master controller 20.

Likewise, the power supply relay 30 is configured to be disabled the by master controller 20 at any time after the actuator motor controller 14 and the actuator motor 16 have performed a position shift in response to a driver command. For example, after an out of park (OOP) command is received from the driver, the master controller 20 enables the power supply relay 30 to provide power to the actuator motor controller 14 and the actuator motor 16. After the OOP shift is performed, the master controller 20 deactivates the power supply relay 30 to prevent inadvertent shifts by the actuator control module 12. The power source output 32 is also configured to provide diagnostics to monitor the power supply relay 30 in accordance with aspects of an exemplary embodiment.

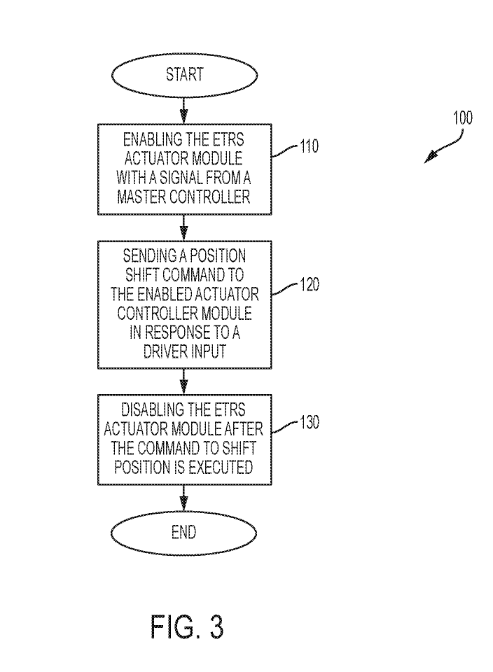

With reference to FIG. 3, an illustration of an algorithm 100 for a redundant hazard mitigation method for an ETRS controls architecture as according to an exemplary embodiment is provided. At block 110, the method begins with enabling the ETRS actuator module 12 with a signal from the master controller 20 to perform an OOP shift. As mentioned above, the master controller 20 may perform the enabling by controlling electric power to the ETRS actuator module 12 or by controlling the enable line 28 of the H-bridge circuit.

Next, at block 120, the method continues with sending a position shift command to the enabled actuator module 12, more particularly the actuator motor controller 14, in response to the driver command. Again, the shift command may by initiated by the master controller 20 sending the shift command to actuator motor controller 14 and/or enabling the H-bridge circuit so that power can be delivered to the actuator motor 16. Alternatively, the master controller 20 may be configured to control a power supply relay 30 to connect power to the ETRS actuator module 12.

At block 130, the method continues with disabling the ETRS module 20 after the command to shift position has been performed. In this manner, the probability of the ETRS actuator module 12 inadvertently performing a shift maneuver is obviated and is primarily under the control of the master controller in accordance with aspects of the exemplary embodiments.

The description of the invention is merely exemplary in nature and variations that do not depart from the gist of the invention are intended to be within the scope of the invention. Such variations are not to be regarded as a departure from the spirit and scope of the invention.

What is claimed is:

1. A redundant hazard mitigation method for an ETRS controls architecture comprising:
enabling an ETRS actuator module to perform a shift position command;
sending a shift position command to the ETRS actuator module; and
disabling the ETRS actuator module after the command to shift position is executed.

2. The method of claim 1 wherein enabling further comprises sending an enable signal from a master controller to the ETRS actuator module in response to a driver command to shift.

3. The method of claim 2 wherein the ETRS actuator module comprises an actuator motor controller in communication with an actuator motor.

4. The method of claim 3 wherein the actuator motor controller and the actuator motor are in communication with a power supply relay.

5. The method of claim 4 wherein enabling further comprises controlling the activation of the power supply relay with the master controller to provide electric power to the ETRS actuator module.

6. The method of claim 3 wherein an H-bridge circuit is in communication between the actuator motor controller and the actuator motor to regulate electric power to the actuator motor.

7. The method of claim 3 wherein an H-bridge circuit is in communication between the master controller and the actuator motor to regulate electric power to the actuator motor.

8. The method of claim 6 wherein enabling further comprises sending an enable signal from the actuator motor controller to the H-bridge in response to a driver input to shift.

9. The method of claim 7 wherein enabling further comprises sending an enable signal from the master controller to the H-bridge in response to a driver command to shift

10. A redundant hazard mitigation method for an ETRS Controls Architecture comprising:
enabling an ETRS actuator module to perform a shift position command by sending an enable signal from a master controller to the ETRS actuator module in response to a driver input to shift;
sending a shift position command to the ETRS actuator module; and
disabling the ETRS actuator module after the command to shift position is executed.

11. The method of claim 10 wherein the ETRS actuator module comprises an actuator motor controller in communication with an actuator motor.

12. The method of claim 11 wherein the actuator motor controller and the actuator motor are in communication with a power supply relay.

13. The method of claim 12 wherein enabling further comprises controlling the activation of the power supply relay with the master controller to provide electric power to the ETRS actuator module.

14. The method of claim 10 wherein an H-bridge circuit is in communication between the actuator motor controller and the actuator motor to regulate electric power to the actuator motor.

15. The method of claim 14 wherein enabling further comprises sending an enable signal from the master controller to the H-bridge in response to a driver command to shift.

16. A redundant hazard mitigation method for an ETRS Controls Architecture comprising:
enabling an ETRS actuator module to perform a shift position command by sending an enable signal from a master controller to the ETRS actuator module in response to a driver input to shift;
controlling the activation of a power supply relay with the master controller to provide power to the ETRS actuator module;
sending a shift position command to the ETRS actuator module after the relay is activated; and
disabling the ETRS actuator module after the command to shift position is executed.

17. The method of claim 16 wherein the ETRS actuator module comprises an actuator motor controller in communication with an actuator motor.

18. The method of claim 17 wherein the actuator motor controller is in communication with the power supply relay.

19. The method of claim 17 wherein an H-bridge circuit is in communication between the actuator motor controller and the actuator motor to regulate electric power to the actuator motor.

20. The method of claim 19 wherein enabling further comprises sending an enable signal from the master controller to the H-bridge in response to a driver command to shift.
